(19) United States
(12) Patent Application Publication
(10) Pub. No.: US 2022/0203759 A1
(43) Pub. Date: Jun. 30, 2022

(54) ADAPTIVE RIM, RIM SYSTEM, VEHICLE AND ASSEMBLY METHOD

(71) Applicant: ORZ GmbH & Co. KG, Munich (DE)

(72) Inventor: Patrick Schittko, Munich (DE)

(21) Appl. No.: 17/565,061

(22) Filed: Dec. 29, 2021

(30) Foreign Application Priority Data
Dec. 31, 2020 (DE) 102020135171.2

(51) Int. Cl. B60B 7/06; B60B 7/18; B60B 7/14

(52) U.S. Cl. CPC B60B 7/065; B60B 2310/305; B60B 7/14; B60B 7/18

(57) ABSTRACT

An adaptive rim has a disk wheel center and a central wheel flange, which are arranged concentrically to one another and are connected to one another. Between the disk wheel center and the wheel flange a detachable connection is formed, wherein the disk wheel center and the wheel flange can be separated from one another after the connection is released. Thus, the wheel flange in the case that it is incompatible with a wheel suspension, can easily be exchanged for another compatible wheel flange. Accordingly, a rim system has at least one rim and a first wheel flange detachably connected to said disk wheel center, and at least one second wheel flange, in which, after the disk wheel center and the first wheel flange have been separated from one another, the second wheel flange instead of the first wheel flange can be detachably connected to the disk wheel center.

The present invention relates to a rim with a disk wheel center and a central wheel flange, which are arranged concentrically to one another and are connected to one another. Furthermore, the present invention relates to a rim system with at least one such rim, a vehicle with such a rim and with a rim of such a rim system as well as a mounting method for mounting a rim on such a vehicle, in which the rim is mounted on a wheel suspension of the vehicle.

Wheel suspensions of vehicles, and in particular of engine-driven motor vehicles, are designed non-uniformly in practice and differ as a rule from vehicle type to vehicle type. In order to be able to mount a wheel on the wheel suspension of a certain vehicle, the wheel must have a wheel flange compatible with the wheel suspension of this vehicle. For this reason, wheels, which are designed for mounting on a certain vehicle type, cannot easily be mounted on wheel suspensions of other vehicle types. If a certain wheel, for example, a wheel with a special shape, is to be provided for mounting on vehicles of different types, this incompatibility necessarily requires the provision of several specimens of wheels of this shape, wherein each of these specimens is designed specially for mounting on vehicles of each of the vehicle types.

One possibility of circumventing this problem and still mounting a wheel that is incompatible with a given wheel suspension on the wheel suspension consists in the interposition of an adapter or adapter element between the wheel and the wheel suspension. Such an adapter, which is arranged between the wheel and the wheel suspension and is mostly disk-shaped, can be connected on one side to the wheel and on its other side to the wheel suspension. For example, perforated disks with appropriately designed holes can be provided as adapters, which can be connected to the wheel suspension by means of screws passed through them and to the wheel by means of screws screwed into threaded holes of the adapter.

However, such adapter elements inevitably lead to a widening of vehicle's track similar to a widening of the track, as is described, for example in DE 20 2019 102 650 U1. In practice, however, such a widening of the track is often undesirable and disadvantageous for a variety of reasons.

The problem addressed by the present invention is therefore to create a way of mounting wheels on wheel suspensions while avoiding a widening of the vehicle's track.

This problem is solved by the adaptive rim, the rim system, the vehicle and the mounting method with the features of the independent claims.

Although the term “rim” in the actual sense only denotes an outer ring for holding a tire, which is connected to the wheel flange via the disk wheel center or the sprocket wheel rim, the colloquial meaning of this term as the wheel of a vehicle without tires is understood below by a rim. In addition to the disk wheel center and the wheel flange detachably connected to the disk wheel center, the rim accordingly also has an outer ring, on which a tire can be arranged. The rim forms a wheel together with a tire arranged on its outer ring. While the disk wheel center connects the outer ring to the wheel flange, the wheel flange is provided for connecting the wheel or, if the tire is missing, the rim to the vehicle's wheel suspension.

In contrast to known rims, in which the disk wheel center and the wheel flange are manufactured in one piece or cast in one piece, welded or riveted together and thus cannot be separated from one another, according to the present invention, in the case of the adaptive or adaptable rim, which is also referred to as an adapter rim, a detachable connection is provided between the disk wheel center and the wheel flange and the disk wheel center and wheel flange can be separated from each other after the connection has been released. In contrast, besides a first wheel flange detachably connected to disk wheel center, the rim system has at least one second wheel flange, but preferably several second wheel flanges, which, after separating the disk wheel center and the first wheel flange, can be detachably connected to the disk wheel center instead of the first wheel flange, or which can be detachably connected to the disk wheel center to form the rim. Accordingly, in the mounting method according to the invention, a disk wheel center and a wheel flange are joined together to form a rim and are detachably connected to one another.

As a result of the detachable connection between the disk wheel center and the wheel flange, the wheel flange can be exchanged for another wheel flange. If the rim was originally configured for mounting on a first wheel suspension and but is now to be mounted on a differently designed second wheel suspension, or if the rim is to be removed again from a first wheel suspension and reassembled on a differently designed second wheel suspension, this can be done by simply replacing the wheel flange with a wheel flange that is compatible with the second wheel suspension. Depending on which vehicle type or which wheel suspension a rim is to be mounted on, the rim that was originally or previously incompatible with the wheel suspension can be easily and quickly adapted or adjusted to a wide variety of wheel suspensions by selecting a suitable wheel flange that is suitable and compatible with the wheel suspension concerned. Additional adapters or adapter elements such as, for example, perforated disks, which have to be interposed between the rims and the wheel suspension in known rims for mounting the rims on wheel suspensions that are incompatible with them, can thus be completely dispensed with. Instead, the rim itself is adapted to the wheel suspension and for this reason the track width of the vehicle does not change or the track width of the vehicle is retained when the rim is installed on the wheel suspension.

In addition, as a result of the interchangeability of the wheel flange, the subject matter of the present invention has the further technical advantage that a targeted change in the track width of vehicles is possible in a simple manner. In order to obtain or set a desired track width of a vehicle, or to change the track width of a vehicle in a targeted manner, it is only necessary to replace the wheel flange of the rim with a wheel flange with a suitable thickness.

Instead of having to have several specimens of a certain rim available, for example, a rim with a specific design, which are compatible with the respective wheel suspensions of different vehicle types, it is sufficient to provide a rim system with only one rim or with only one disk wheel center and several wheel flanges that are appropriately designed and detachably connectable with the disk wheel center. The effort and costs for material and storage can be reduced as a result.

The wheel flange can thereby be made entirely or partially from metal and in particular from light metal or from fiber-reinforced plastic. The same applies to the disk wheel center. In particular, the wheel flange and disk wheel center can each be made from different materials or from the same material. Furthermore, the wheel flange preferably has a round shape or outer contour, but it is also possible to design the wheel flange with a polygonal outer contour, for example, square, pentagonal or hexagonal.

The interchangeability of the wheel flange is particularly advantageous, when the wheel flange is damaged, which can happen, for example, when the tires are repeatedly changed seasonally in motor vehicles, or when connecting devices of the wheel flange, such as threaded holes, wear down or wear out when the rim is attached and removed several times. In such cases, the damaged wheel flange can simply be exchanged for an undamaged wheel flange and the rim can continue to be used, without having to dispose of the entire rim just because of a damaged wheel flange. For these reasons, a rim system is preferred in which at least two or all wheel flanges are designed differently and/or in which at least two of the wheel flanges are identical. Furthermore, an embodiment of the mounting method is preferred, in which a connection between the disk wheel center and a first wheel flange of a rim of a rim system is released, the disk wheel center and the first wheel flange are separated from one another, a second wheel flange, instead of the first wheel flange, is joined together with the disk wheel center to form the rim, the disk wheel center and the second wheel flange are detachably connected to one another, and the rim, which has the second wheel flange and the disk wheel center, is mounted on the wheel suspension of the vehicle.

In general, the detachable connection between the disk wheel center and the wheel flange can be designed in various ways. For example, in the case of the rim, the disk wheel center and the wheel flange can be connected to one another by means of screws and/or a clamping device and/or a latching device and/or a positive connection and/or by means of bolts and nuts screwed onto them. Screw connections ensure a particular stability and reliability of the connection, while clamping devices and latching devices are characterized in that the connection can be quickly and easily released and re-established with them. When the disk wheel center and the wheel flange are connected by means of bolts or wheel bolts and nuts or wheel nuts screwed onto them, the bolts can be pressed into the wheel flange and passed through the disk wheel center, similar to known track widening disks. The disk wheel center and wheel flange can then be fixed to one another by means of the nuts screwed onto the bolts or onto the end pieces of the bolts protruding from the disk wheel center. Alternatively, however, the bolts can also be pressed into the disk wheel center and passed through the wheel flange, wherein nuts are screwed onto end pieces of the bolts protruding from the wheel flange. The disk wheel center or the wheel flange advantageously have suitable depressions, in which the screwed-on nuts are received and thus do not protrude on the surface of the disk wheel center or the wheel flange. If several bolts are present, combinations of these types of fastening are also possible. For example, one or more first bolts can be pressed into the wheel flange and passed through the disk wheel center and one or more second bolts can also or simultaneously be pressed into the disk wheel center and passed through the wheel flange.

An inflated tire received in the outer ring of the rim presses on the inside of the ring, so that frictional forces between the tire and the inside of the ring normally prevent them from moving relative to one another. In exceptional situations such as extremely strong acceleration or braking, however, it is possible that the frictional forces are overcome and the tire shifts in relation to the outer ring or the rim. Particularly preferably, the rim therefore has at least one device which is configured to prevent the tire and the rim, or an outer ring of the rim receiving the tire, from shifting or twisting relative to each other when a tire is arranged on the rim. An example of such a device are the mechanical devices commonly known as “beadlocks”. A beadlock prevents the tires from slipping through by fixing the tire to the rim. To connect the tire to the outer ring or the rim, a ring with several screws arranged all around is often used, particularly in four-wheel drive vehicles. Inner tubes inserted into the tire are also known as beadlocks and are inflated to fix them.

In a further preferred embodiment of the rim, the wheel flange is designed with a recess for receiving a hub of a wheel suspension and/or the disk wheel center is designed as a spoke wheel center or a wheel disk. Wheel suspensions often have a hub, in order to simplify the mounting and, in particular, the centering of rims during their mounting, the hub being received in the recess of the wheel flange. In this case, the recess can be designed as a continuous hole or as a through hole, which is pierced completely or partially by the hub, or as a non-continuous or closed recess. Furthermore, a disk wheel center designed as a spoke wheel center can have at least one or a plurality of spokes or can be designed as a spoke wheel. On the other hand, a disk wheel center designed as a wheel disk can be designed with a closed surface, and in particular without structures or smooth.

The rim can be provided for a wide variety of vehicles or crafts, and in particular for mobile means of transport that are used to transport people, goods or tools. These vehicles can in general be land vehicles such as passenger cars, trucks, road vehicles, off-road vehicles or rail-bound vehicles. Since aircraft such as helicopters and airplanes such as, for example, propeller planes or jet planes are also generally equipped with wheels, the vehicle can also be an aircraft. The same applies to spacecraft, for example for landing modules of spacecraft. The rim can also be used in vehicles, that are combinations of these vehicle types with one another or a combination of one of these vehicle types with a watercraft, as is the case, for example, with an amphibious vehicle or a seaplane. In particular, the vehicle can be a model vehicle or a toy vehicle, for example, a miniaturized and/or remote-controlled model car or model airplane or an electric model or toy train.

It is irrelevant whether and how the vehicle is operated. The vehicle can either be non-motorized and can be operated by muscle power and/or by at least one internal combustion engine and/or by at least one electric motor and/or by means of hydrogen. In particular, the vehicle can be a simple wagon or carriage that is intended for pulling by people or animals such as horses or for use on tractors.

The invention is explained in more detail below on the basis of preferred exemplary embodiments and with the aid of figures.

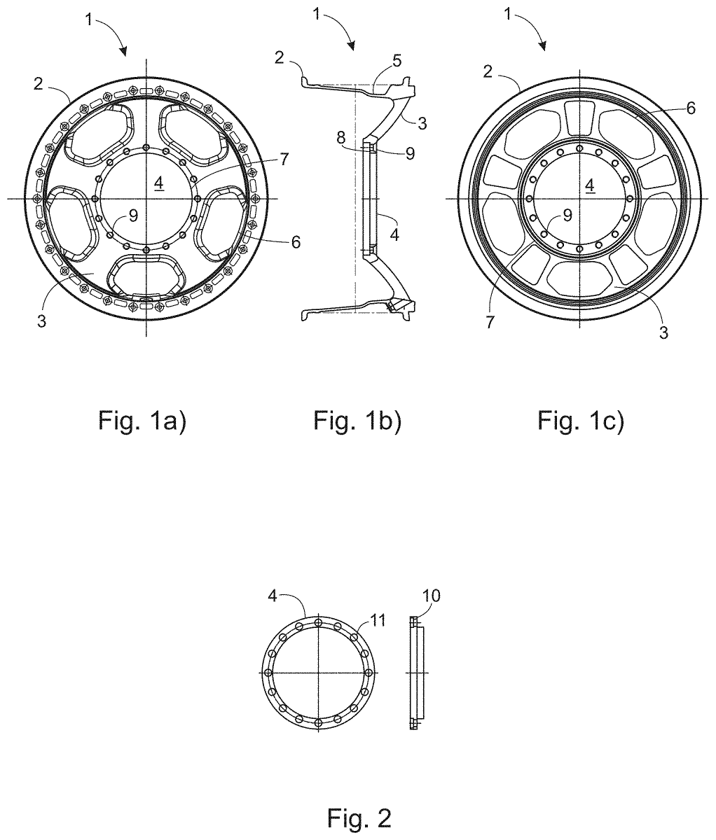

FIG. 1a) shows a front view of an adaptive rim;

FIG. 1b) shows a cross section through the rim of FIG. 1a);

FIG. 1c) shows a rear view of the rim of FIG. 1a);

FIG. 2 shows a wheel flange;

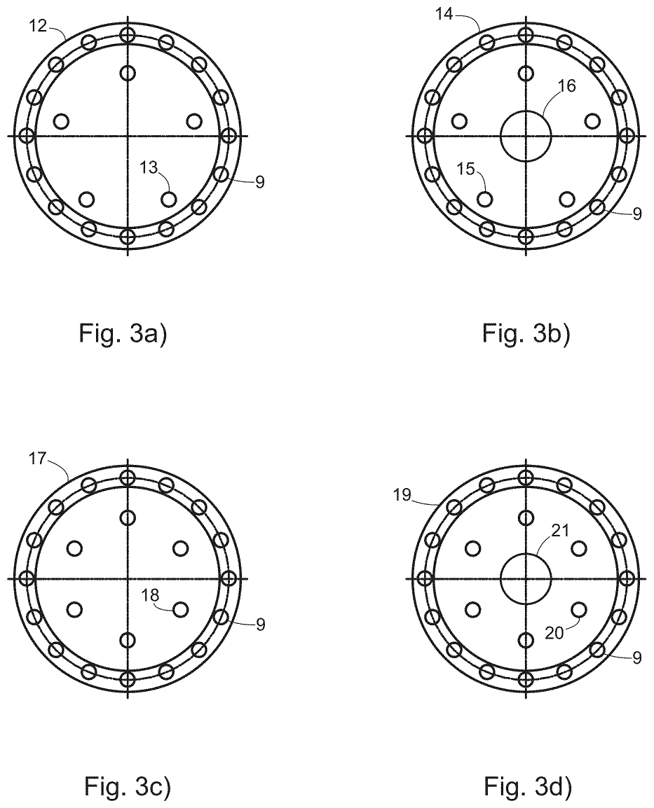

FIG. 3a)-d) shows several differently designed wheel flanges.

FIG. 1a) shows a rim 1 or adapter rim for a passenger car in a front view or from the front, while FIG. 1b) shows a cross section through the rim 1. In contrast, the rim 1 can be seen in FIG. 1c) in a rear view or from the rear. The rim 1 has a peripheral outer ring 2, a disk wheel center 3 and a wheel flange 4.

The outer ring 2 is designed in a known manner with a circumferential and outwardly open depression 5 for receiving a tire not shown in the figures. After mounting a tire on the ring 2, the combination of the circumferential tire and the rim 1 forms a wheel, which is provided for mounting on a wheel suspension of the passenger vehicle. In principle, however, the rim 1 can also be mounted on a wheel suspension without a tire mounted on it. In particular, the rim 1 or the wheel can be equipped with a beadlock device.

In the present case, the disk wheel center 3 is a bowl-like sprocket wheel rim with design-related openings 6. At its outer periphery, the disk wheel center 3 is connected to the outer ring 2, which extends around the entire circumference of the disk wheel center 3. The exact shape of the disk wheel center 3 is irrelevant, so that the disk wheel center 3 could alternatively also be designed as a spoke wheel center, with one or more spokes or as a smooth wheel disk without openings 6. A through hole 7 is also formed in the center of disk wheel center 3, wherein the disk wheel center 3 has a reduced thickness along an end section 8 extending circumferentially around the through hole 7 or surrounding or enclosing the through hole 7. As can be seen in the cross section of FIG. 1b), the disk wheel center 3 has a recess along the end section 8 and is designed step-like as a result of this or it has a step as a result, wherein when the rim 1 is mounted on the wheel suspension of the passenger car the recess is facing the latter. A plurality of bores 9 are provided at regular intervals along the end section 8.

The wheel flange 4 is arranged within the through hole 7 of the disk wheel center 3 or the wheel flange 4 is arranged to close the through hole 7. As can be seen in FIG. 2, in which the wheel flange 4 is shown in a top view and in a side view, the wheel flange 4 is essentially disk-shaped. It has a stepped end section 10 complementary to the step-like recess of the end section 8 of the disk wheel center 3, wherein the end section 8 is received in the recess of the end section 10 and vice versa. The end sections 8 and 10 thus rest against one another or they come into contact. In particular, threaded bores 11 are formed along the end section 10, which correspond to the bores 9 of the end section 8 of the disk wheel center 3. The wheel flange 4 is thereby detachably connected to the disk wheel center 3 by means of screws, wherein in each case a screw extends through each of the bores 9, which screw engages with a respective threaded bore 11 and is screwed into it.

By means of the wheel flange 4, the rim 1 can now be mounted on the wheel suspension. For this purpose, the wheel flange is designed with corresponding bores for screw connections, which in turn are compatible with threaded bores of the wheel suspension and which are indeed not shown in FIGS. 1 and 2 for reasons of clarity but also for generality, but which FIGS. 3a) -d) show for four differently designed wheel flanges.

Thus, a front view of a wheel flange 12 with five bores 13 arranged symmetrically about the central axis of the wheel flange 12 can be seen in FIG. 3a). FIG. 3b) shows a wheel flange 14, which also has five symmetrically arranged bores 15. In addition to the bores 15, the wheel flange 14 is provided with a recess 16 for receiving hubs of wheel suspensions, in order to facilitate the mounting of the rim 1. In contrast, the wheel flange 17 of FIG. 3c) has six bores 18 arranged symmetrically about the central axis, while the wheel flange 19 of FIG. 3d) has, in addition to six symmetrically arranged bores 20, a central recess for a hub 21 of a wheel suspension.

It is obvious that each of the wheel flanges 12, 14, 17 and 19 of FIGS. 3a)-d) can only be connected to a respectively compatible wheel suspension. Only the wheel flange 12 can be mounted on a wheel suspension with five symmetrical threaded bores that does not have a central hub, while only the wheel flange 19 can be mounted on a wheel suspension with six symmetrical threaded bores and a central hub. The same applies to the wheel flanges 14 and 17. However, like the wheel flange 4, each of the four wheel flanges 12, 14, 17, 19 can be connected to the disk wheel center 3, since all five wheel flanges 4, 12, 14, 17, 19 have circumferential bores 9, which are arranged in accordance with the threaded bores 11 of the disk wheel center 3.

If the disk wheel center 3 were permanently or non-detachably connected to one of the wheel flanges 4, 12, 14, 17 and 19, as is the case with known rims, the rim 1 could not be mounted on a vehicle without an additional adapter, which has a wheel suspension not compatible with its wheel flange 4 , 12, 14, 17, 19. Or else the rim 1 would have to be completely replaced by another rim.

However, since in the case of rim 1 the disk wheel center 3 and the wheel flange 4 are detachably connected to one another, they can be separated after releasing and removing the screws extending through the bores 9 and screwed into the threaded bores 11. The wheel flange 4, which is not compatible with the wheel suspension, can now be exchanged for a suitable one of the wheel flanges 12, 14, 17 and 19. After connecting the respectively matching wheel flange 12, 14, 17 and 19 to the disk wheel center 3, which is done by means of screws as with the replaced wheel flange 4, the rim 1 now adapted to the wheel suspension, with which it was previously incompatible or with which its original wheel flange 4 is not compatible, can be mounted on the wheel suspension.

Thus, the rim 1 in combination with the wheel flanges 12, 14, 18 and 19 forms a rim system which allows the rim 1 to be adapted to a plurality of different wheel suspensions or to make it compatible with them.

It goes without saying that the rim system is not only limited to four additional wheel flanges and in particular also not to the wheel flanges 12, 14, 18 and 19 shown in FIGS. 3a)-d), but rather that the rim system can have any number of wheel flanges and also wheel flanges compatible with any number of different wheel suspensions.

In addition, the rim system can also have two or more identically designed wheel flanges so that, in the event of damage to a wheel flange, it can be quickly exchanged for a new or undamaged wheel flange for the same wheel suspension.

### LIST OF REFERENCE SIGNS

1. rim
2. ring
3. disk wheel center
4. wheel flange
5. depression
6. opening
7. through hole
8. end section
9. bore
10. end section
11. threaded bore
12. wheel flange
13. bore
14. wheel flange
15. bore
16. recess
17. wheel flange
18. bore
19. wheel flange
20. bore
21. recess

1. An adaptive rim (1) with a disk wheel center (3) and a central wheel flange (4, 12, 14, 17, 19), which are arranged concentrically to one another and are connected to one another,
characterized in that
a detachable connection is formed between the disk wheel center (3) and the wheel flange (4, 12, 14, 17, 19) and the disk wheel center (3) and wheel flange (4, 12, 14, 17, 19) can be separated from one another after the connection has been released.

2. The adaptive rim (1) according to claim 1, in which the disk wheel center (3) and the wheel flange (4, 12, 14, 17, 19) are connected to one another by means of screws and/or a clamping device and/or a latching device and/or a positive connection and/or by means of bolts and nuts screwed on to them.

3. The adaptive rim (1) according to claim 1 with at least one device, which is configured to prevent the tire and the rim (1) from shifting or twisting relative to one another when a tire is arranged on the rim (1).

4. The adaptive rim (1) according to claim 1, in which the wheel flange (14, 19) is designed with a recess (16, 21) for receiving a hub of a wheel suspension and/or in which the disk wheel center (3) is designed as a spoke wheel center or as a wheel disk.

5. A rim system with at least one adaptive rim (1) according to claim 1, which has a disk wheel center (3) and a first wheel flange (4) detachably connected to said disk wheel center, and at least one second wheel flange (12, 14, 17, 19), wherein after the disk wheel center (3) and the first wheel flange (4) have been separated from one another the second wheel flange instead of (12, 14, 17, 19) the first wheel flange (4) can be detachably connected to the disk wheel center (3).

6. The rim system according to claim 5, in which at least two or all wheel flanges (4, 12, 14, 17, 19) are designed differently and/or in which at least two of the wheel flanges (4, 12, 14, 17, 19) are identical.

7. A vehicle with at least one adaptive rim (1) with a disk wheel center and a central wheel flange, which are arranged concentrically to one another and are connected to one another, characterized in that a detachable connection is formed between the disk wheel center and the wheel flange and the disk wheel center and wheel flange can be separated from one another after the connection has been released and/or with at least one adaptive rim (1) at least of one rim system according to claim 5.

8. The vehicle according to claim 7, in which it is a land vehicle, an aircraft or a spacecraft or a model vehicle or a toy vehicle.

9. The vehicle according to claim 7, which can be operated either by muscle power and/or by at least one internal combustion engine and/or by at least one electric motor and/or by means of hydrogen.

10. A mounting method for mounting an adaptive rim (1) with a disk wheel center and a central wheel flange, which are arranged concentrically to one another and are connected to one another, characterized in that a detachable connection is formed between the disk wheel center and the wheel flange and the disk wheel center and wheel flange can be separated from one another after the connection has been released or an adaptive rim (1) of a rim system according to any one of claim 5 or 6 on a vehicle according to claim 7, in which
a disk wheel center (3) and a wheel flange (4, 12, 14, 17, 19) are joined together to form the rim (1),
the disk wheel center (3) and the wheel flange (4, 12, 14, 17, 19) are detachably connected to one another, and
the rim (1) is mounted on a wheel suspension of the vehicle.

11. The mounting method according to claim 10, in which
a connection between the disk wheel center (3) and a first wheel flange (4) of a rim (1) of a rim system is released,
the disk wheel center (3) and the first wheel flange (4) are separated from one another,
a second wheel flange (12, 14, 17, 19) instead of the first wheel flange (4) is joined together with the disk wheel center (3) to form the rim (1),
the disk wheel center (3) and the second wheel flange (12, 14, 17, 19) are detachably connected to one another, and
the rim (1) having the second wheel flange (12, 14, 17, 19) and the disk wheel center (3) is mounted on the wheel suspension of the vehicle.
